(19) United States
(12) Patent Application Publication
(10) Pub. No.: US 2022/0413361 A1
(43) Pub. Date: Dec. 29, 2022

(54) BLADE DRIVING DEVICE, CAMERA DEVICE AND ELECTRONIC APPARATUS

(71) Applicant: New Shicoh Motor Co., Ltd., Zhejiang (CN)

(72) Inventor: Xuepeng FU, Yamato City (JP)

(21) Appl. No.: 17/846,566

(22) Filed: Jun. 22, 2022

(30) Foreign Application Priority Data
Jun. 23, 2021 (CN) 202110699798.3
Jun. 23, 2021 (CN) 202110701487.6

(51) Int. Cl. G03B 9/06; H04N 5/225; G01B 7/00

(52) U.S. Cl. CPC G03B 9/06; H04N 5/2253; G01B 7/003

(57) ABSTRACT

According to an embodiment, a blade driving device in which a central axis is defined includes a plurality of blades and a plurality of groups. The blades are arranged around the central axis. Each of the groups has a magnet and at least two coils and the groups are arranged at intervals along a circumference of a circle centered on the central axis. A winding axis direction of the coil coincides with a normal direction of a facing surface of the magnet facing the coil, magnetic poles formed on the facing surface are reversed at a position corresponding to a center of the coil when viewed from the winding axis direction, and each of the groups generates an electromagnetic force along a circumference direction of the circle to drive the blades.

### CROSS-REFERENCE TO RELATED APPLICATIONS

This application claims the benefit of Chinese Patent Applications No. 202110701487.6 and 202110699798.3, each filed on Jun. 23, 2021, which are hereby incorporated by reference herein in its entirety.

### TECHNICAL FIELD

The present disclosure relates to a blade driving device used in electronic apparatus such as smartphones, a camera device and an electronic apparatus.

### BACKGROUND

Various techniques have been proposed to adjust the amount of light in the lens body by sliding the blades of the camera device. The camera module disclosed in Chinese Patent Publication No. 110858048A (hereinafter referred to as “Patent Document 1”) has three blades arranged around the incident hole, and these three blades are driven to change the amount of light incident on the lens body. In this camera module, three driving coils are arranged on the FPC (Flexible Printed Circuits) on the bottom surface of the housing that holds the blades and three driving magnets are arranged on the movable ring facing the housing, respectively, and the movable ring is rotated about the optical axis by the electromagnetic force generated by the driving coils and the driving magnets to move the blades. The diaphragm mechanism device disclosed in Korean Patent Publication No. 2018-0105970A (hereinafter referred to as “Patent Document 2”) has two substantially L-shaped blades called blades facing each other around the incident hole, and these two blades are driven to change the amount of light incident on the lens body. In this diaphragm mechanism device, three coils are arranged on the FPC on the bottom surface of the base and three permanent magnets are arranged on the rotation ring on the upper side of the base, respectively, and the rotation ring is rotated about the optical axis by the electromagnetic force generated by the coils and the permanent magnets to move the blades.

However, in the techniques described in Patent Documents 1 and 2, there was a problem that a plurality of groups consisting of one coil and one magnet whose surface facing this coil is magnetized to two different magnetic poles are arranged around the incident hole, and the spatial efficiency of the electromagnetic force generation is low. In addition, there was a problem that the dimensional restrictions were severe, and it was difficult to arrange position sensors around the driving coil.

### SUMMARY

The present disclosure has been made in view of such problems, and one of objects thereof is to provide a blade driving device with a high spatial efficiency of electromagnetic force generation, and another one of the objects thereof is to provide a blade driving device in which a position sensor can be arranged even in a small space.

In accordance with a first aspect of the present disclosure, there is provided a blade driving device in which a central axis is defined, including a plurality of blades and a plurality of groups. The blades are arranged around the central axis. Each of the groups has a magnet and at least two coils and the groups are arranged at intervals along a circumference of a circle centered on the central axis. A winding axis direction of the coil coincides with a normal direction of a facing surface of the magnet facing the coil, magnetic poles formed on the facing surface are reversed at a position corresponding to a center of the coil when viewed from the winding axis direction, and each of the groups generates an electromagnetic force along a circumference direction of the circle to drive the blades.

In accordance with a second aspect of the present disclosure, there is provided a camera device including the blade driving device described above.

In accordance with a third aspect of the present disclosure, there is provided an electronic apparatus including the camera device described above.

Further features of the present invention will become apparent from the following description of exemplary embodiments with reference to the attached drawings.

### BRIEF DESCRIPTION OF DRAWINGS

FIG. 1 is a front view of a smartphone on which a camera device is mounted, the camera device including a blade driving device according to a first embodiment of the present disclosure;

FIG. 2 is a perspective view of the blade driving device and the lens driving device 5 of FIG. 1;

FIG. 3 is a perspective view of the blade driving device of FIG. 2;

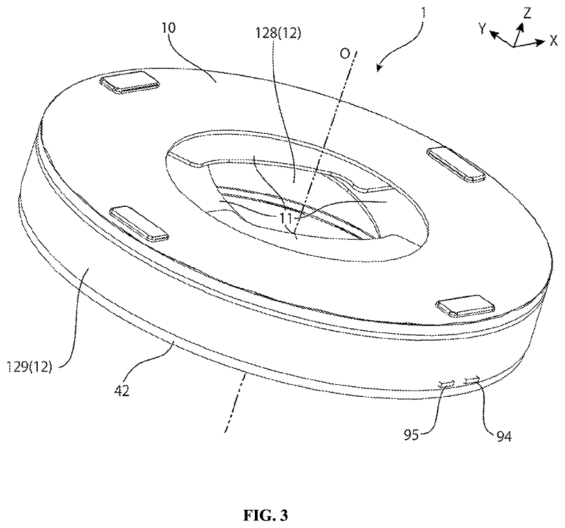

FIG. 4 is an exploded perspective view of the blade driving device of FIG. 3;

FIG. 5 is a diagram in which the cover 10, the blade and the fixed plate are removed;

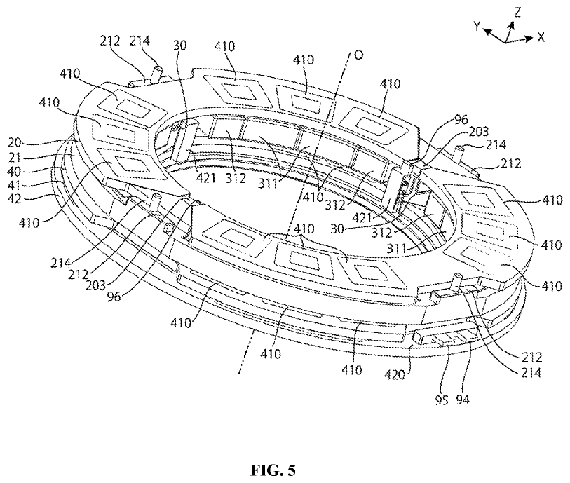

FIG. 6 is a diagram in which the front side coil substrate is removed from FIG. 5;

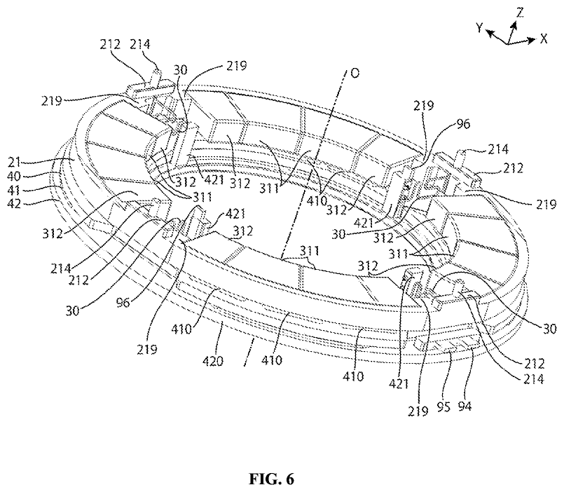

FIG. 7 is a diagram in which the magnet pieces and are removed from FIG. 6;

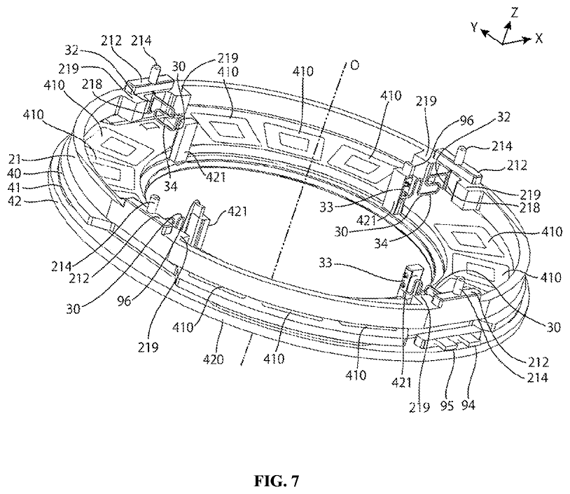

FIG. 8 is a front view of a smartphone on which a camera device is mounted, the camera device including a blade driving device according to a second embodiment of the present disclosure;

FIG. 9 is a perspective view of the blade driving device of FIG. 8;

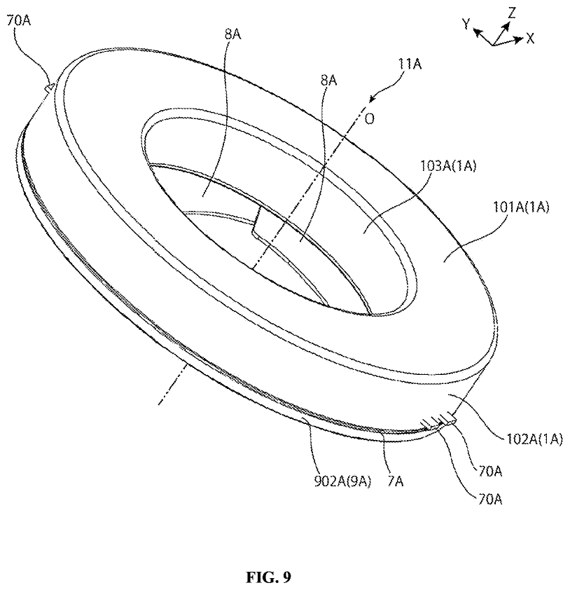

FIG. 10 is an exploded perspective view of the blade driving device of FIG. 9;

FIG. 11 is a diagram in which the front cover is removed from FIG. 9;

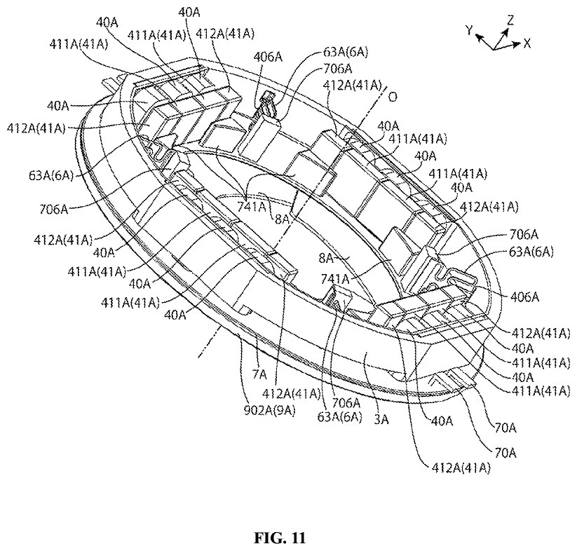

FIG. 12 is a front view of a smartphone on which a camera device is mounted, the camera device including a blade driving device and a lens driving device according to the third embodiment of the present disclosure;

FIG. 13 is a perspective view of the blade driving device and the lens driving device of FIG. 12;

FIG. 14 is a perspective view of the blade driving device of FIG. 13;

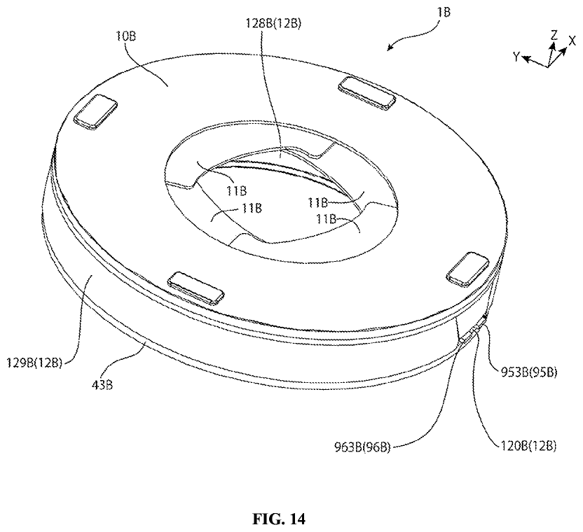

FIG. 15 is an exploded perspective view of the blade driving device of FIG. 14;

FIG. 16 is a diagram in which the cover is removed from FIG. 14;

FIG. 17 is a diagram in which the blade is removed from FIG. 16;

FIG. 18 is a diagram in which the fixed plate is removed from FIG. 17;

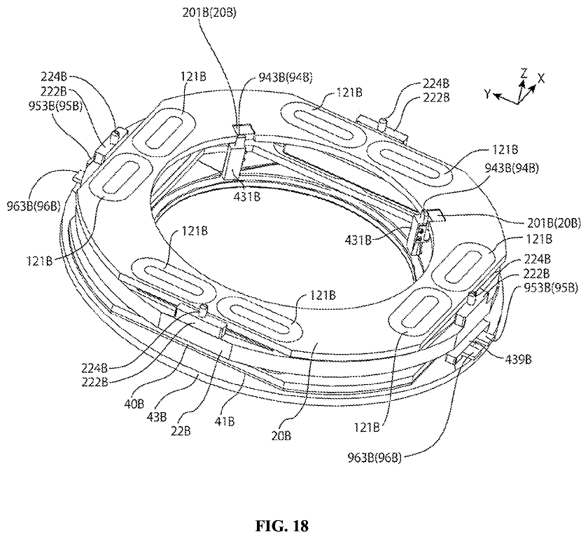

FIG. 19 is a diagram in which the front side coil substrate is removed from FIG. 18;

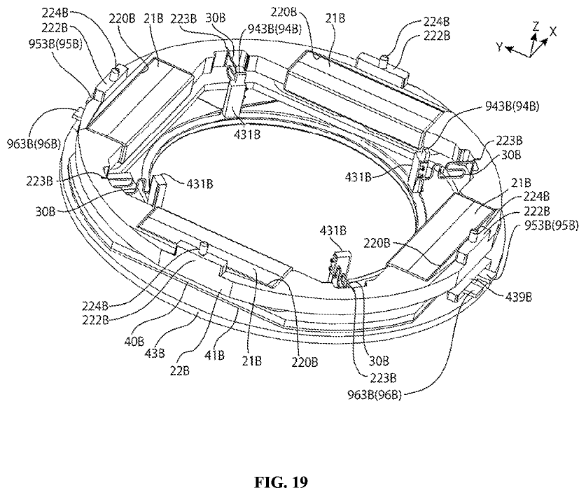

FIG. 20 is a diagram in which the movable ring is removed from FIG. 19;

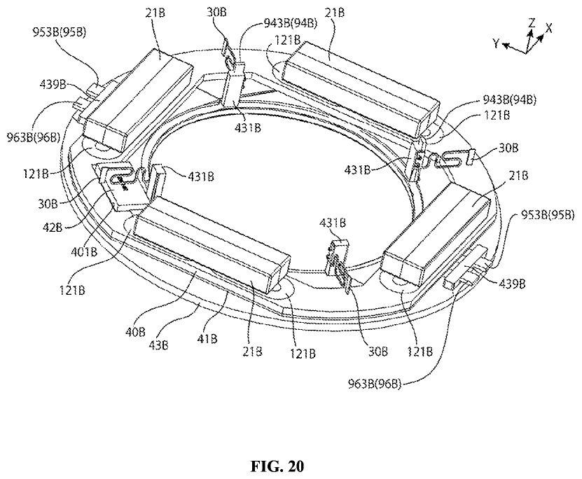

FIG. 21 is a diagram showing the base of FIG. 20; and

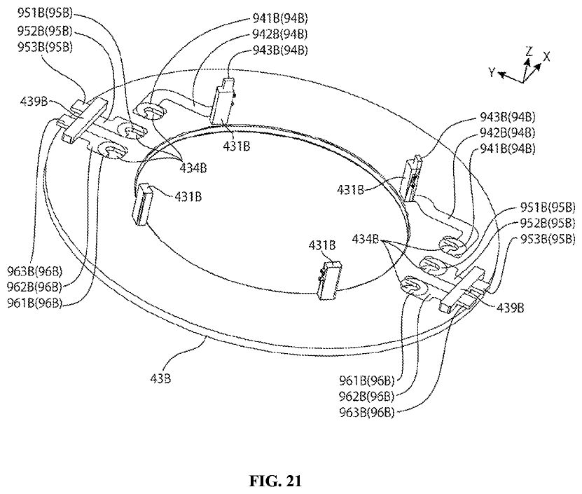

FIG. 22 is a diagram showing the rear side coil substrate, the Hall IC and the base of the blade driving device according to another embodiment of the present disclosure.

### DETAILED DESCRIPTION OF THE DRAWINGS

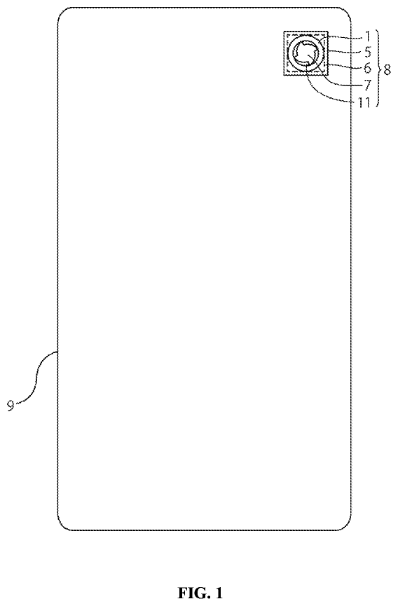

Hereinafter, the first embodiment of the present disclosure is explained with reference to drawings. As shown in FIG. 1, a camera device 8 including a blade driving device 1 according to the first embodiment of the present disclosure is accommodated in a smartphone 9.

The camera device 8 includes: a lens body 7; an image sensor 6 that converts light from the lens body 7 into an electrical signal; a lens driving device 5 that drives the lens body 7; and a blade driving device 1 that drives the blades 11 arranged on the front side of the lens body 7.

Hereinafter, the direction in which the light from the subject is incident is appropriately referred to as a Z direction, one direction orthogonal to the Z direction is appropriately referred to as an X direction, and a direction orthogonal to both the Z direction and the X direction is appropriately referred to as a Y direction. Further, the +Z side of the optical axis of the lens body 7, which is the side of the subject, may be referred to as a front side, and the −Z side, which is the side on which the image sensor 6 on the opposite side of the subject is provided, may be referred to as a rear side.

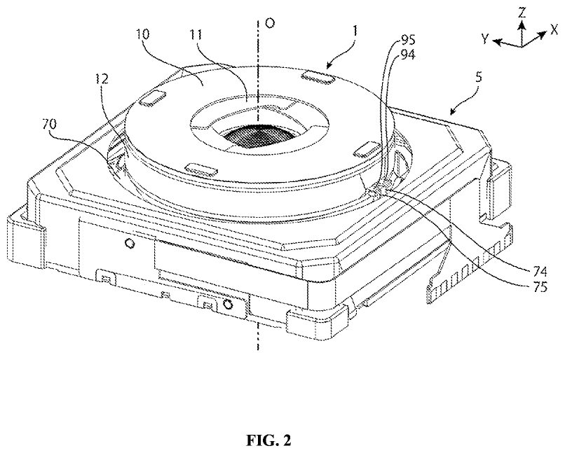

As shown in FIG. 2, the lens driving device 5 has a lens carrier 70 inside thereof, and the lens carrier 70 holds the lens body 7. Metallic receiving portions 74 and 75 are provided on the +Y side and the −Y side of the front surface of the lens carrier 70. The receiving portions 74 and 75 extend toward the +Z side. The lens driving device 5 supports the metal members 94 and 95 protruding to the −Y side and the +Y side of the blade driving device 1 by the receiving portions 74 and 75, and supplies power to the blade driving device 1 via the receiving portions 74 and 75 and the metal members 94 and 95. The blade driving device 1 is configured such that the optical axis of the lens body 7 becomes the central axis of the blade driving device 1 and is attached to the lens carrier 70. The central axis is an axis passing through the center of the blade driving device 11 in the Z direction, and the central axis direction and the Z direction are the same. The central axis direction may also be a front-rear direction.

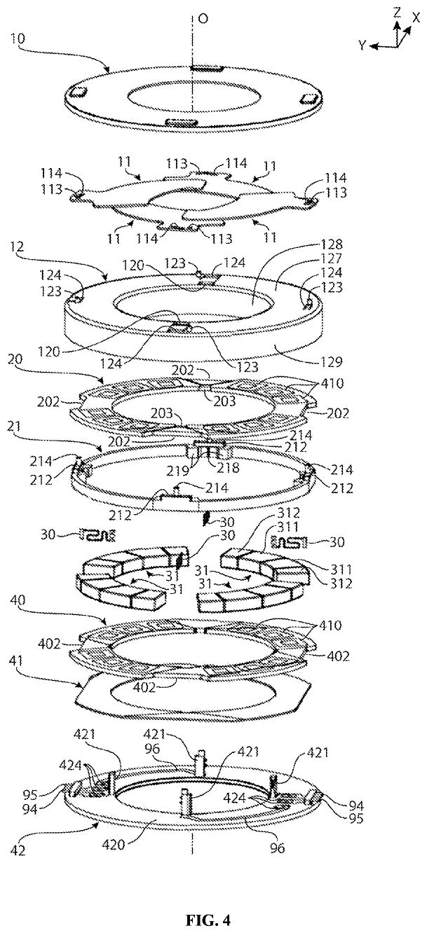

As shown in FIG. 4, the blade driving device 1 includes a cover 10, four blades 11, a fixed plate 12, a front side coil substrate 20, a movable ring 21, four plate springs 30, four magnets 31, a rear side coil substrate 40, a circuit board 41, and a base 42. Among these, the cover 10, the fixed plate 12, the front side coil substrate 20, the rear side coil substrate 40, the circuit board 41 and the base 42 constitute a fixed portion which is not accompanied by movement with respect to the lens carrier 70.

The cover 10 is formed in an annular plate shape centered on the central axis. The blade 11 is a flat plate, and four blades 11 of the same shape are arranged at 90° intervals. The protruding portion protruding from the outer edge of the blade 11 is provided with a fixing hole 113 and a movable hole 114. The fixing hole 113 has a circular shape. The movable hole 114 extends in an intermediate direction between the radial direction and the tangential direction of the circumference. An aperture is formed on inner peripheral side of the four blades 11. By rotating the blades 11 around the fixing holes 113, the size of this aperture is controlled, and the amount of light from the subject to the image sensor 6 via the lens body 7 is controlled.

The fixed plate 12 has a front side wall portion 127, an inner peripheral wall portion 128, and an outer peripheral wall portion 129. Fixing pins 123 and long holes 124 are provided at positions near to each other at the outer peripheral edge on the +X side, the −X side, the +Y side, and the −Y side of the front side wall portion 127, respectively. The fixing pin 123 and the long hole 124 are provided close to each other in the tangential direction of a circle, and the long hole 124 extends in the tangential direction of the circumference. In addition, holes 120 are provided at the inner peripheral edge of the front side wall portion 127 on the +X side and the −X side, respectively. The inner peripheral wall portion 128 and the outer peripheral wall portion 129 extend to the −Z side from the inner peripheral edge and the outer peripheral edge of the front side wall portion 127, and the fixed plate 12 has an annular shape centered on the central axis as viewed from the central axis direction.

The front side coil substrate 20 is formed in an annular plate shape centered on the central axis. Notches 202 are provided at positions on the +X side, the −X side, the +Y side, and the −Y side of the outer periphery of the front side coil substrate 20.

Every three coils 410 are embedded on the +X+Y side, the +X−Y side, the −X+Y side, and the −X−Y side of the front side coil substrate 20, respectively. The three coils 410 are arranged adjacent to each other along the circumference direction. Each coil 410 is formed with the central axis direction as the winding axis and has a linear portion in an approximately radial direction.

Lands 203 are provided at positions on the +X side and the −X side of the inner periphery of the front side coil substrate 20. The holes 120 of the fixed plate 12 are provided at positions corresponding to the lands 203. The electric current flows from one land 203 into each coil 410 arranged in the front side coil substrate 20 to reach the other land 203.

The movable ring 21 is formed in an annular shape with a width in the front and rear. There are table portions 212 protruding forward at the outer peripheral edge on the +X side, the −X side, the +Y side and the −Y side of the front surface of the movable ring 21, respectively, and each table portion 212 is provided with a movable pin 214 protruding further forward. On the +X, the −X side, the +Y side and the −Y side of the inner peripheral wall of the movable ring 21, slits 218 are provided in the front-rear direction toward the outside in the radial direction of the movable ring 21. Convex portions 219 protruding inward are provided on both sides of the slit 218.

The plate spring 30 has an inner edge portion 32, an outer edge portion 33, and an arm portion 34 elastically connecting the inner edge portion 32 and the outer edge portion 33. The arm portion 34 is constituted of a thread-like winding elastic member.

The magnet 31 is formed by arranging and sticking four magnet pieces 311 and 312 in an arc shape. The circumferential width of two magnet pieces 312 at both ends of the magnet 31 is equal to or half the circumferential width of two magnet piece 311 in the center. The magnet pieces 311 and 312 of the magnet 31 are magnetized in the front-rear direction, and the magnetic poles in the plate surface direction (the front-rear direction, that is, the central axis direction) of the adjacent magnet pieces 311 and 312 are magnetized so as to be opposite magnetic poles. Therefore, the areas of portions magnetized to one magnetic pole at both ends of the magnet 31 are smaller than the areas of other portions magnetized to one magnetic pole.

The rear side coil substrate 40 is formed in an annular plate shape centered on the central axis. Notches 402 are provided at positions on the +X side, the −X side, the +Y side, and the −Y side of the outer periphery of the rear side coil substrate 40.

Every three coils 410 are embedded on the +X+Y side, the +X−Y side, the −X+Y side and the −X−Y side of the rear side coil substrate 40, respectively. The three coils 410 are arranged adjacent to each other along the circumference direction. Each coil 410 is formed with the central axis direction as the winding axis and has a linear portion in an approximately radial direction.

On the rear surface of the rear side coil substrate 40, two lands (not shown) are provided at positions of the outer periphery on the +X side. The electric current flows from one land into each coil 410 arranged in the rear side coil substrate 40 to reach the other land.

The circuit board 41 is an annular plate with a circular inside and a rounded-corner quadrangular outside. On the +Y side and the −Y side of the rear surface of the circuit board 41, three lands (not shown) are provided corresponding to the holes hole 424, respectively. In addition, two lands (not shown) are provided at positions of the outer periphery on the +X side of the rear surface. In addition, a Hall IC (not shown) is provided on the front surface of the circuit board 41.

The base 42 is insert-molded with the main body of the base 42 made of resin, and two first metal members 94, two second metal members 95 and two third metal members 96 embedded in the resin.

The base 42 has an annular bottom plate 420. Column portions 421 rising on the +Z side are provided on the +X side, the −X side, the −Y side and the +Y side of the inner peripheral edge of the bottom plate 420. Every three holes 424 are provided on the +Y side and the −Y side of the base 42, respectively. The three holes 424 are aligned in the X direction.

Each first metal member 94 extends between the hole 424 on the right side and the outer edge of the bottom plate 420 as viewed from the outer peripheral side. One end portion of each first metal member 94 is exposed forward and rearward in the hole 424 on the +X side. The other end portion of each first metal member 94 rises in a stepped shape at the outer edge of the bottom plate 420 and then projects outside the bottom plate 420.

Each second metal member 95 extends between the hole 424 in the middle and the outer edge of the bottom plate 420. One end portion of each second metal member 95 is exposed forward and rearward in the hole 424 in the middle. The other end portion of each second metal member 95 rises in a stepped shape at the outer edge of the bottom plate 420 and then projects outside the bottom plate 420.

Each third metal member 96 extends between the hole 424 on the left side and the column portion 421 on the +X side or the −X side as viewed from the outer peripheral side. One end portion of each third metal member 96 is exposed forward and rearward in the hole 424 on the left side as viewed from the outer peripheral side. The other end portion of each third metal member 96 rises at the column portion 421 and extends forward along the column portion 421. The front end of the rising portion of each third metal member 96 protrudes to the tip of the front edge of the column portion 421 and is exposed.

The blade driving device 1 is manufactured as follows:

First, the rear side coil substrate 40 is fixed to the front surface of the circuit board 41. Two lands on the rear surface of the rear side coil substrate 40 and two lands on the outer periphery on the +X side of the rear surface of the circuit board 41 are soldered from the rear side. Thereby, the output portion of the Hall IC (not shown) provided on the circuit board 41 is electrically connected to the rear side coil substrate 40.

Next, the circuit board 41 is fixed to the front surface of the bottom plate 420 of the base 42. The first metal member 94, the second metal member 95 and the third metal member 96 are soldered to the lands on the rear side of the circuit board 41 via the holes 424 of the base 42. Thereby, the Hall IC (not shown) provided on the circuit board 41 is electrically connected to the outside of the blade driving device 1 via the first metal member 94 and the second metal member 95, and the output portion of the Hall IC is also electrically connected to the third metal member 96. In addition, the rear side coil substrate 41 can increase the size of the coil 410 in the radial direction while preventing interference with the first metal member 94 and the second metal member 95 by the notches 402 provided on the +Y side and the −Y side.

Separately, the magnet 31 is fitted between two convex portions 219 between the adjacent slits 218 of the movable ring 21 to fix the movable ring 21 and the magnet 31. The outer edge portion 33 of the plate spring 30 is inserted into and fixed to the slit 218. The movable ring 21 incorporated with the magnets 31 is arranged on the base 42, and the inner edge portions 32 of the plate spring 30 are fixed to the column portions 421 of the base 42. At this time, the movable ring 21 is supported in a floating state with respect to the base 42 by the plate springs 30.

The front side coil substrate 20 is previously fixed to the rear surface of the front side wall portion 127 of the fixed plate. At this time, the lands 203 of the front side coil substrate 20 are made to be peeked through the hole 120 of the fixed plate 12. Then, the rear edges of the inner peripheral wall portion 128 and the outer peripheral wall portion 129 of the fixed plate 12 are fixed to the inner peripheral edge and the outer peripheral edge of the bottom plate 420 of the base 42 by fitting the movable pins 214 into the long holes 124. The front side coil substrate 20 can increase the size of the coil 410 in the radial direction while preventing interference with the movable pin 214 by the notch 202. The front side coil substrate 20 is electrically connected by soldering the lands 203 to the front ends of the third metal members 96 of the base 42 via the holes 120. Thereby, the front side coil substrate 20 is electrically connected to the output portion of the Hall IC (not shown) provided on the circuit board 41.

Next, the blades 11 are attached to the fixed plate 12. At this time, the fixing pins 123 of the fixed plate 12 are fitted into the fixing holes 113 of the blades 11, and the movable pins 214 of the movable ring 21 penetrating the long holes 124 of the fixed plate 12 are fitted into the movable holes 114 of the blades 11. Finally, the cover 10 is attached to the fixed plate 12.

After completion of the blade driving device 1, the receiving portions 74 and 75 of the lens driving device 5 are welded or soldered to the rear surfaces of the first metal members 94 and the second metal members 95 exposed outside the base 42.

On the +X side, the −X side, the +Y side and the −Y side, the three coils 410 of the front side coil substrate 20 and the three coils 410 of the rear side coil substrate 40 face each other with the magnets 31 sandwiched therebetween. That is, both plate surfaces of the plate-like magnet 31 are facing surfaces to the coil 410, and the magnetic poles are formed on the facing surfaces. In the direction in which the magnet pieces 311 and 312 of each magnet 31 are aligned, when viewed from the radial direction of the circle, the magnetic poles formed on the facing surface are reversed at a position corresponding to the center of each coil 410. Therefore, each linear portion extending in the radial direction of each coil 410 faces the facing surface of the magnet 31 where the magnetic poles are formed.

When an electric current is supplied to the coils 410 of the front side coil substrate 20 and the rear side coil substrate 40 of the blade driving device 1, an electromagnetic force is generated in the tangential direction of the circumference by the coils 410 and the magnets 31, and a thrust force in a direction around the central axis is produced. The movable ring 21 rotates with respect to the fixed plate 12 by this thrust force. With this rotation, the movable pin 214 of the movable ring 21 moves in the long hole 124 of the fixed plate 12 and the movable hole 114 of the blade 11, and the blade 11 rotates around the axis of the fixing pin 123 fitted in the fixing hole 113.

The details of the present first embodiment are explained above. The blade driving device 1 according the present first embodiment, in which a central axis is defined, includes: a plurality of blades 11 arranged around the central axis; and a plurality of groups having magnets 31 and at least two coils 410 and arranged at intervals along the circumference of a circle centered on the central axis, wherein the winding axis direction of the coil 410 and the normal direction of the facing surface of the magnet 31 facing the coil 410 face the central axis direction, magnetic poles formed on the facing surface are reversed at a position corresponding to the center of each coil 410 as viewed from the radial direction of the circle, and each of the groups generates an electromagnetic force along the circumference direction of the circle to drive the blades 11. Each of the plurality of groups has at least two coils 410. Thus, it is possible to provide a blade driving device 1 with a high spatial efficiency of electromagnetic force generation.

It is to be noted that in the first embodiment described above, in one group, the magnet 31 may be constituted by two magnetic pole pieces 312 and may be made to face coils 410 arranged on the front side and on the rear side, one by one, respectively. In addition, the magnet 31 may be made into one magnetic pole piece 311 and may be made to face two coils 410 arranged on either the front side or the rear side. In this case, in the alignment direction of the coils 410, the end portions of the magnet 31 become the smallest combination at positions corresponding to the centers of the coils 410 at both ends. In addition, more than three coils 410 may be used in one group. Further, the number of the coils 410 and the number of the magnetic poles of the plate surface of the magnet 31 facing the coil 410 may be different for each group. In addition, the number of the groups of the magnets 41 and the coils 40 may be two groups, three groups, or five groups or more.

In addition, in the first embodiment described above, the coil substrate may be provided only on either the front side or the rear side of the magnet 31.

Furthermore, in the first embodiment described above, the coil 410 may be fixed to the movable ring 3, and magnet 31 may be fixed to the fixed portion.

Moreover, in the first embodiment described above, the magnet 31 and coils 410 in each group may be linearly connected and aligned. In addition, the magnet 31 may not use individual magnet pieces 311, 312, but simply reverse the magnetization direction.

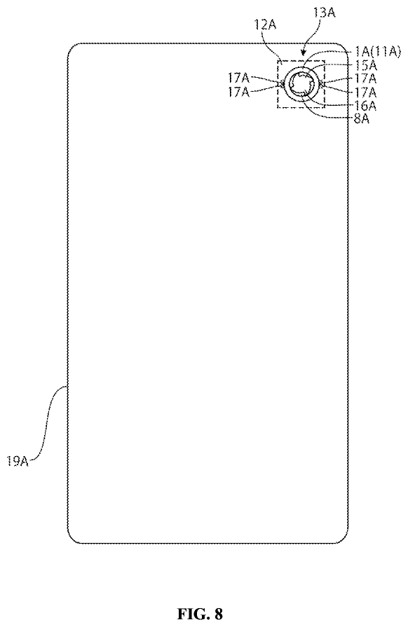

Hereinafter, the second embodiment of the present disclosure is explained with reference to drawings. As shown in FIG. 8, a camera device 13A including a blade driving device 11A according to the second embodiment of the present disclosure is accommodated in a smartphone 19A.

The camera device 13A includes: a lens body 15A; an image sensor 16A that converts light from the lens body 15A into an electrical signal; a lens driving device 12A that drives the lens body 15A; and a blade driving device 11A that drives the blades 8A arranged on the front side of the lens body 15A.

Hereinafter, the direction in which the light from the subject is incident is appropriately referred to as a Z direction, one direction orthogonal to the Z direction is appropriately referred to as an X direction, and a direction orthogonal to both the Z direction and the X direction is appropriately referred to as a Y direction. Further, the +Z side of the optical axis of the lens body 15A, which is the side of the subject, may be referred to as a front side, and the −Z side, which is the side on which the image sensor 16A on the opposite side of the subject is provided, may be referred to as a rear side.

The lens driving device 12A has a lens carrier that movably holds the lens body 15A in the optical axis direction. The blade driving device 11A is configured such that the optical axis of the lens body 15A becomes the central axis of the blade driving device 11A. The central axis is an axis passing through the center of the blade driving device 11A in the Z direction, and the central axis direction and the Z direction are the same. The central axis direction may also be a front-rear direction. In the lens driving device 12A, metallic receiving portions 17A are provided at ends on the −Y side and +Y side of the front surface of the lens carrier. The receiving portions 17A extend toward the +Z side. The blade driving device 11A has metal members 70A that protrude in the −Y direction and the +Y direction from an outer peripheral wall of the blade driving device 11A. The lens driving device 12A supports the metal members 70Aby the receiving portions 17A, and supplies electric power to the blade driving device 11A via the receiving portions 17A and the metal members 70A.

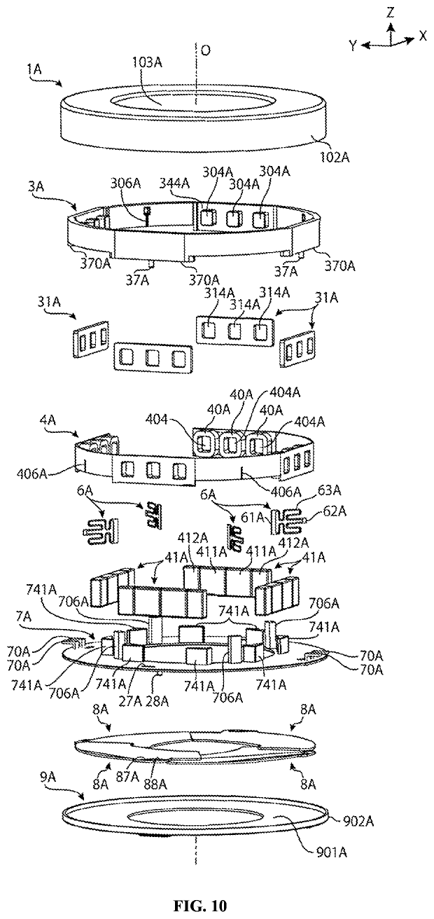

As shown in FIG. 10, the blade driving device 11A includes a front cover 1A, a movable ring 3A, four yokes 31A, an FPC 4A, twelve coils 40A, four plate springs 6A, four magnets 41A, a base 7A, four blades 8A, and a rear cover 9A. Among these, the front cover 1A, the magnets 41A, the base 7A, and the rear cover 9A constitute a fixed portion which is not accompanied by movement with respect to the lens driving device 12A.

The front cover 1A has a front side wall portion 101A, an outer peripheral wall portion 102A, and an inner peripheral wall portion 103A. The inner peripheral wall portion 103A and the outer peripheral wall portion 102A extend to the −Z side from the inner peripheral edge and the outer peripheral edge of the front side wall portion 101A, and the front cover 1A has an annular shape when viewed from the central axis direction.

The movable ring 3A is formed in an approximately annular shape with a width in the front and rear. Grooves 344A recessed outward and passing through in the front and rear are provided on the +X side, the −X side, the +Y side, and the −Y side of the inner surface of the movable ring 3A. The bottom of the groove 344A is a flat surface. The grooves 344A are respectively provided with three convex portions 304A. The three convex portions 304A on the +X side and the −X side are separated and aligned in the Y direction. The three convex portions 304A on the +Y side and the −Y side are separated and aligned in the X direction. There are table portions 370A protruding rearward at the rear edge on the +X side, the −X side, the +Y side, and the −Y side of the movable ring 3A, respectively, and each table portion 370A is provided with a movable pin 37A protruding further rearward. Slits 306A extending forward and rearward are provided on the +X+Y side, the +X−Y side, the −X+Y side and the −X−Y side of the movable ring 3A.

The yoke 31A is a magnetic plate and has a rectangular shape. The yoke 31A is provided with rectangular hole portions 314A corresponding to the convex portions 304A.

The FPC 4A has a shape such that a portion of the +X+Y side of a circular ring with a width in the front and rear is cut off. The FPC 4A is provided with rectangular hole portions 404A corresponding to the convex portions 304A. On the +X side, the −X side, the +Y side and the −Y side of the inner surface of the FPC 4A, three coils 40A are fixed corresponding to the hole portions 404A, respectively. The three coils 40A on the +X side and the −X side are separated and aligned in the Y direction and wound with the X axis as the winding axis. The three coils 40A on the +Y side and the −Y side are separated and aligned in the X direction and wound with the Y axis as the winding axis. Slits 406A extending forward and rearward are provided on the +X−Y side, the −X+Y side and the −X−Y side of the FPC 4A.

The plate spring 6A has an inner edge portion 61A, an outer edge portion 62A, and an arm portion 63A elastically connecting the inner edge portion 61A and the outer edge portion 62A. The arm portion 63A is constituted of a thread-like winding elastic member.

The magnets 41A are attached to the base 7A and provided on the +X side, the −X side, the +Y side and the −Y side. Each magnet 41A is formed by bonding four magnet pieces 411A and 412A together so as to form a rectangular parallelepiped shape as a whole. The magnets 41A on the +X side and the −X side have magnet pieces 411A, 412A aligned in the Y direction and magnetized surfaces in the X direction. The magnets 41A on the +Y side and the −Y side have magnet pieces 411A, 412A aligned in the X direction and magnetized surfaces in the Y direction. The two magnet pieces 411A in the center of the magnet 41A are formed in a square shape as viewed from the plate surface direction. The two magnet pieces 412A at both ends are formed in a rectangular shape with a width equal to or half the width of the magnet piece 411A in the alignment direction. The magnet pieces 411A and 412A of the magnet 41A are magnetized so that the magnetic poles of the adjacent magnet pieces 411A and 412A in the plate surface direction become opposite magnetic poles. Therefore, the areas of portions magnetized to one magnetic pole at both ends of the magnet 41A are smaller than the areas of other portions magnetized to one magnetic pole.

The base 7A is formed in an annular plate shape. Four metal members 70A are embedded in the base 7A so as to surround the through hole in the center of the base 7A. One end portions of two metal members 70A on the +Y side rise in a stepped shape at the outer edge on the +Y side of the base 7A and then project outward, and one end portions of two metal members 70A on the −Y side rise in a stepped shape at the outer edge on the −Y side of the base 7A and then project outward. Other end portions of the metal members 70A rise together with the column portions 706A from the peripheral edge portion surrounding the through hole of the base 7A.

Two table portions 741A are provided at intervals on the +X side, the −X side, the +Y side, and the −Y side of the inner peripheral edge portion surrounding the through hole of the base 7A, respectively. The surfaces of the two table portions 741A facing the outer peripheral side are each a part of the same plane. The column portions 706A rise from the peripheral edge portion surrounding the through hole between the adjacent table portions 741A. Long holes 27A and fixing pins 28A are provided at positions near to each other at the outer peripheral edge on the +X side, the −X side, the +Y side and the −Y side of the base 7A, respectively. The long holes 27A and the fixing pins 28A are provided close to each other in the tangential direction of the circle, and the long holes 27A extend in the tangential direction of this circumference. The fixing pins 28A extend rearward from the rear surface of the base 7A.

The blade 8A is a flat plate, and four blades 8A of the same shape are arranged at 90° intervals to form an aperture in the center. The protruding portion protruding from the outer edge of the blade 8A is provided with a movable hole 87A and a fixing hole 88A. The movable hole 87A extends in an intermediate direction between the radial direction and the tangential direction of the circumference, and the fixing hole 88A has a circular shape.

The rear cover 9A has an annular bottom surface portion 901A, and an edge portion 902A protruding to the +Z side from the outer peripheral edge.

The blade driving device 11A is manufactured as follows.

The magnets 41A are fixed to the surfaces facing the outer peripheral sides of the table portions 741A of the base 7A manufactured by previously embedding the metal members70A. In addition, the yokes 31A are fixed to the grooves 344A of the movable ring 3A, and the FPC 4A is fixed to the inside thereof. The convex portions 304A of the movable ring 3A are fitted into the hole portions 314A of the yokes 31A and the hole portions 404A of the FPC 4A. In addition, the slits 306A of the movable ring 3A and the slits 406A of the FPC 4A are made to coincide with each other. Next, the coils 40A are attached, fixed and electrically connected to the FPC 4A so that the convex portions 304A are fitted into the central hole.

Next, the outer edge portions 62A of the plate springs 6A are fixed to the slits 306A of the movable ring 3A, and are electrically connected to the FPC 4A at the slits 406A. Then, the inner edge portions 61A of the plate springs 6A are fixed and electrically connected to the metal members 70A of the base 7A which rise together with the column portions 706A. Thus, the movable ring 3A on which the coils 40A, the yokes 31A and the FPC 4A are mounted is supported by the column portions 706A of the base 7A via the plate springs 6A. In addition, the magnets 41A and the coils 40A face each other. In addition, the movable pins 37A of the movable ring 3A are fitted into the long holes 27A of the solid plate 7.

Next, the blades 8A are attached to the base 7A. The fixing pin 28A of the base 7A is attached so as to be fitted into the fixing hole 88A of the blade 8A, and the movable pin 37A of the movable ring 3A extending further rearward from the long hole 27A is attached so as to be fitted into the movable hole 87A of the blade 8A. Finally, the front cover 1A and the rear cover 9A are fixed to the base 7A. That is, the inner peripheral wall portion 103A and the outer peripheral wall portion 102A of the front cover 1A are fixed to the inner peripheral edge and the outer peripheral edge of the through hole of the base 7A. In addition, the edge portion 902A of the rear cover 9A is fixed to the outer peripheral edge of the base 7A.

After completion of the blade driving device 11A, the rear surfaces of the exposed portions on the +Y side and the −Y side of the four metal members 70A of the blade driving device 11A are welded or soldered to the front surfaces of the receiving portions 17 of the lens driving device 12.

A magnet 41A and three coils 40A constitute a group on each of the +X side, the −X side, the +Y side and the −Y side. In each group, the magnet pieces 411A, 412 constituting the magnet 41A are linearly aligned as viewed from the central axis direction. Similarly, in each group, the coils 40A are linearly aligned as viewed from the central axis direction. The magnet 41A and the coils 40A in each group face each other in parallel. In the alignment direction of the magnet pieces 411A and 412A in the magnet 41A, the boundary of the magnetic poles, which are the boundary of the magnet pieces 411A, 412A, is located at a position corresponding to the center of each coil 40A. That is, the magnetic poles are reversed at this position.

When an electric current is supplied to the coils 40A, a thrust force in a direction around the central axis is produced by the electromagnetic force generated by the coils 40A and the magnets 41A. The movable ring 3A rotates with respect to the base 7A by this thrust force.

With this rotation, the movable pin 37A of the movable ring 3A moves in the long hole 27A of the base 7A and the movable hole 87A of the blade 8A, and the blade 8A rotates around the axis of the fixing pin 28A fitted in the fixing hole 88A. By the rotation of the four blades 8A, the size of the aperture surrounded by the inner periphery of the four blades 8A is changed, and the amount of light from the subject to the image sensor 16A via the lens body 15A is controlled. Then, when the electric current supplied to the coils 40A is stopped, the movable ring 3A returns to the original position, the four blades 8A return to the original positions, and the aperture returns to the original state by the elastic force of the plate springs 6A.

The details of the present second embodiment are explained above. The blade driving device 11A according to the present second embodiment, in which a central axis is defined, includes: a plurality of blades 8A arranged around the central axis; and a plurality of groups each having at least one coil 40A and one magnet 41A and arranged at intervals along the circumference of a circle centered on the central axis, wherein the winding axis direction of the coil 40A and the normal direction of a facing surface of the magnet 41A facing the coil 40A face the radial direction centered on the central axis as a whole, magnetic poles formed on the facing surface are reversed at a position corresponding to the center of the coil when viewed from the central axis direction, and each of the groups generates an electromagnetic force along the circumference direction of the circle to drive the blades 8A. The portion of the coil 40A extending in the central axis direction is effectively used. Thus, it is possible to provide a blade driving device 11A with a high spatial efficiency of electromagnetic force generation.

It is to be noted that in the second embodiment described above, in one group, the magnet 41A may be made into two magnetic pole pieces 412A and may be made to face one coil 40A. In addition, the magnet 41A may be made into one magnetic pole piece 411 and may be made to face two coils 40A. In this case, in the alignment direction of the coils 40A, the end portions of the magnet 41A become the smallest combination at positions corresponding to the centers of the coils 40A at both ends. In addition, more than three coils 40A may be used in one group. In addition, the number of the coils 40A and the number of the magnetic poles of the plate surface of the magnet 41A facing the coil 40A may be different for each group. In addition, the number of the groups of the magnets 41 and the coils 40 may be two groups, three groups, or five groups or more.

In addition, in the second embodiment described above, the magnets 41A may be arranged on the movable ring 3A and the coils 40A may be arranged on the fixed plate 7. Furthermore, the coils 40A may be arranged on the outer peripheral side and the magnets 41A may be arranged on the inner peripheral side. In addition, in each group, the magnet pieces 411A, 412A of the magnet 41A and the coil 40A may be connected and aligned along the circumference direction of the circle. Moreover, the magnet 41A may not use individual magnet pieces 411A, 412A, but simply reverse the magnetization direction.

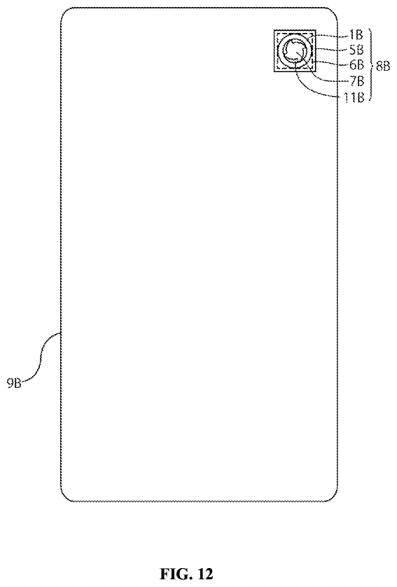

Hereinafter, the third embodiment of the present disclosure is explained with reference to drawings. As shown in FIG. 12, a camera device 8B including a blade driving device 1B according to the third embodiment of the present disclosure is accommodated in a smartphone 9B.

The camera device 8B includes: a lens body 7B; an image sensor 6B that converts light from the lens body 7B into an electrical signal; a lens driving device 5B that drives the lens body 7B; and a blade driving device 1B that drives the blades 11B arranged on the front side of the lens body 7B.

Hereinafter, the direction in which the light from the subject is incident is appropriately referred to as a Z direction, one direction orthogonal to the Z direction is appropriately referred to as an X direction, and a direction orthogonal to both the Z direction and the X direction is appropriately referred to as a Y direction. In addition, the +Z side of the optical axis of the lens body 7B which is the side of the subject, may be referred to as a front side, and the −Z side, which is the side on which the image sensor 6B on the opposite side of the subject is provided, may be referred to as a rear side. In addition, the +X side may be referred to as an upper side, the −X side may be referred to a lower side, the +Y side may be referred to a left side, and the −Y side may be referred to a right side.

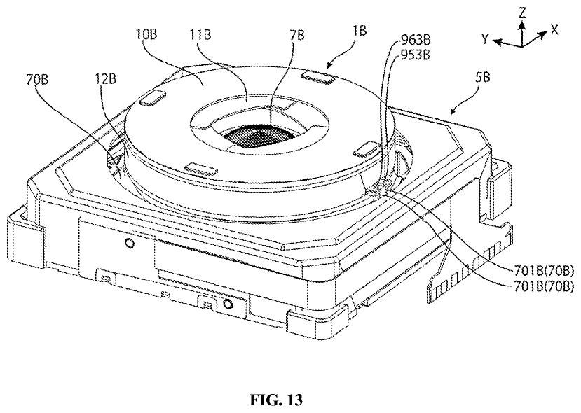

As shown in FIG. 13, the lens driving device 5B has a lens carrier 70B inside thereof, and the lens carrier 70B holds the lens body 7B. On the +Y side and the −Y side of the front surface of the lens carrier 70B, metallic carrier side receiving portions 701B for supporting the blade driving device 1B and supplying electric power to the blade driving device 1B are provided. Blade side receiving portions 953B,963B are provided correspondingly to the blade driving device 1B. The blade driving device 1B is configured such that the optical axis of the lens body 7B becomes the center of the blade driving device 1B. Since the blade driving device 1B is supported by the carrier side receiving portions 701B and the blade side receiving portions 953B, 963, the blade driving device 1B does not come into contact with the lens body 7B. The lens carrier 70B is supported movably at least in the optical axis direction of lens body 7B, and the blade driving device 1B moves together with the lens carrier 70B and the lens body 7B.

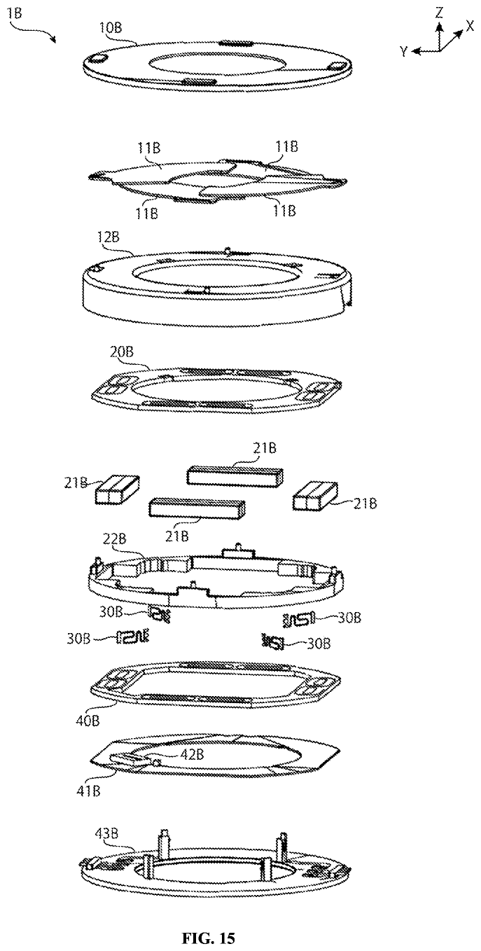

As shown in FIG. 15, the blade driving device 1B has a cover 10B, four blades 11B, a fixed plate 12B, a front side coil substrate 20B, four magnets 21B, a movable ring 22B, four plate springs 30B, a rear side coil substrate 40B, a circuit board 41B, a Hall IC 42B, and a base 43B. Among these, the cover 10B, the fixed plate 12B, the front side coil substrate 20B, the rear side coil substrate 40B, the circuit board 41B, the Hall IC 42B, and the base 43B constitute a fixed portion which is not accompanied by movement with respect to the lens carrier 70B.

The cover 10B is formed in an annular shape. The blade 11B is a flat plate, and four blades 11B are circularly arranged. A portion protruding in an approximately rectangular shape at the outer edge of the blade 11B is provided with a fixing hole 113B and a movable hole 114B. The fixing hole 113B is formed in a perfect circular shape. The movable hole 114B has a shape in which the perfect circle is extended in its diameter direction. An aperture is formed on the inner peripheral side of the four blades 11B. By rotating the blades 11B around the fixing holes 113B, the size of this aperture is controlled, and the amount of light from the subject to the image sensor 6B via the lens body 7B is controlled.

The fixed plate 12B has a disk portion 127B, an inner peripheral wall portion 128B and an outer peripheral wall portion 129B. Fixing pins 123B and long holes 124B are provided at positions near to each other at the outer peripheral edge on the +X side, the −X side, the +Y side and the −Y side of the disk portion 127B, respectively. The fixing pin 123B and the long hole 124B are provided close to each other in the tangential direction of a circle, and the long hole 124B extends in the tangential direction of the circumference. In addition, holes 125B are provided at the inner peripheral edge of the disk portion 127B on the +X+Y side and the +X−Y side, respectively. The inner peripheral wall portion 128B and the outer peripheral wall portion 129B extend to the −Z side from the inner peripheral edge and the outer peripheral edge of the disk portion 127B. Notches 120B are provided on the +Y side and the −Y side of the rear end of the outer peripheral wall portion 129B.

The front side coil substrate 20B is formed in an annular shape. Every two coils 121B are embedded on the +X side, the −X side, the +Y side and the −Y side of the through hole in the center of the front side coil substrate 20B, respectively. The two coils 121B arranged on the +X side and the −X side are aligned in the Y direction and each of them has linear portions extending in the Y direction. The two coils 121B arranged on the +Y side and the −Y side are aligned in the X direction and each of them has linear portions extending in the X direction. Eight coils 121B are aligned at the same height. Lands 201B are provided at positions on the +X+Y side and the +X−Y side of the inner peripheral edge of the front side coil substrate 20B. Two lands 201B are electrically connected to each other via respective coils 121B arranged in the front side coil substrate 20B.

The movable ring 22B is formed in an annular shape. On the +X side, the −X side, the +Y side and the −Y side of the inner peripheral wall of the movable ring 22B, there are recess portions 220B recessed to the outer peripheral side. Magnets 21B are accommodated in and fixed to the recess portions 220B on the +X side, the −X side, the +Y side and the −Y side, respectively. The magnet 21B is magnetized in the front-rear direction so that the inner peripheral side half and the outer peripheral side half become opposite magnetic poles. There are table portions 222B protruding forward at the outer peripheral edge on the +X side, the −X side, the +Y side and the −Y side of the front surface of the movable ring 22B, respectively, and each table portion 222B is provided with a movable pin 224B protruding further forward. Slits 223B are provided on the +X+Y side, the +X−Y side, the −X+Y side and the −X−Y side of the inner peripheral wall of the movable ring 22B, that is, between the recess portion 220B and the recess portion 220B. The slit 223B is recessed outward in the radial direction of the movable ring 22B.

The plate spring 30B has two plate-like portions and an arm portion elastically connecting the two plate-like portions. The arm portion is constituted of a thread-like winding elastic member.

The rear side coil substrate 40B is formed in an annular shape. Every two coils 121B are embedded on the +X side, the −X side, the +Y side and the −Y side of the through hole in the center of the rear side coil substrate 40B, respectively. The two coils 121B arranged on the +X side and the −X side are aligned in the Y direction and each of them has linear portions extending in the Y direction. The two coils 121B arranged on the +Y side and the −Y side are aligned in the X direction and each of them has linear portions extending in the X direction. Eight coils 121B are aligned at the same height. A rectangular notch 401B is provided at a position on the −X+Y side of the inner peripheral edge of the rear side coil substrate 40B, that is, at a position between the coil 121B on the −X side and the coil 121B on the +Y side. Two lands (not shown) are provided on the +X side of the outer peripheral edge of the rear side coil substrate 40B. The two lands are electrically connected to each other via respective coils 121B arranged in the rear side coil substrate 40B.

The circuit board 41B is formed in an annular shape. A Hall IC 42B is fixed to a position corresponding to the notch 401B on the −X+Y side of the front surface of the circuit board 41B. The Hall IC 42B is a magnetic position sensor. Six lands (not shown) are provided at a position of the circuit board 41B where the Hall IC 42B is fixed. The six lands are electrically connected to six pads of the Hall IC 42B.

Two lands (not shown) are provided on the +X side of the outer peripheral edge of the circuit board 41B. Three lands (not shown) are provided on the +Y side and the −Y side of the rear surface of the circuit board 41B, respectively.

The base 43B is insert-molded with the main body of the base 43B made of resin, and two first metal members 94B, two second metal members 95B and two third metal members 96B embedded in the resin.

The base 43B has an annular bottom surface. Column portions 431B rising on the +Z side are provided on the +X+Y side, the +X−Y side, the −X+Y side and the −X−Y side of the inner peripheral edge surrounding the central through hole in the base 43B. Every three holes 434B are provided on the +Y side and the −Y side of the base 43B, respectively. The three holes 434B are aligned in the X direction.

Each first metal member 94B has an exposed portion 941B which is exposed in a hook-like shape in front and rear in the hole 434B on the +X side, an embedded portion 942B which protrudes from the exposed portion 941B to the +X side in an embedded state and extends to the nearest column portion 431B while bending, and a rising portion 943B which rises at the column portion 431B and extends forward along the column portion 431B. The front-end portion of the rising portion 943B protrudes to the tip of the front edge of the column portion 431B and is exposed.

Each second metal member 95B has an exposed portion 951B which is exposed in a hook-like shape in front and rear in the middle hole 434B, an embedded portion 952B which extends from the exposed portion 951B toward the outer periphery side in an embedded state, and a blade side receiving portion 953B which rises in a stepped shape at the tip end of the embedded portion 952B and then projects outside the outer edge of the base 43B.

Each third metal member 96B has an exposed portion 961B which is exposed in a hook-like shape in front and rear in the hole 434B on the −X side, an embedded portion 962B which extends from the exposed portion 961B toward the outer periphery side in an embedded state, and a blade side receiving portion 963B which rises in a stepped shape at the tip end of the embedded portion 962B and then projects outside the outer edge of the base 43B.

The rising portions of the blade side receiving portions 953B and 963 are covered by a laterally long slender plate portion 439B in the X direction, and the blade side receiving portions 953B and 963 project outwards from the side surface of the slender plate portion 439B.

The blade driving device 1B is manufactured as follows.

The circuit board 41B is fixed to the front surface of the base 43B. The exposed portions941B, 951B and 961B on the +Y side and the exposed portions 941B, 951B and 961B on the −Y side of the base 43B are soldered to three lands on the +Y side and three lands on the −Y side of the circuit board 41B, respectively.

The rear side coil substrate 40B is fixed to the front surface of the circuit board 41B. The Hall IC 42B on the circuit board 41B is accommodated in the notch 401B on the −X+Y side of the rear side coil substrate 40B. Two lands on the +X side of the circuit board 41B is soldered to two lands on the +X side of the rear side coil substrate 40B, respectively. The rising portion 943B of the first metal member 94B of the base 43B extends forward through the edge of the through hole of the circuit board 41B.

The movable ring 22B to which the magnets 21B are previously fixed is supported in the air via the four plate springs 30B on the outer peripheral side of the four column portions 431B of the base 43B. The plate-like portion on the inner periphery side of the plate spring 30B is fixed to the side surface of the column portion 431B. The plate-like portion on the outer peripheral side of the plate spring 30B is inserted into and fixed to the slit 223B of the movable ring 22B.

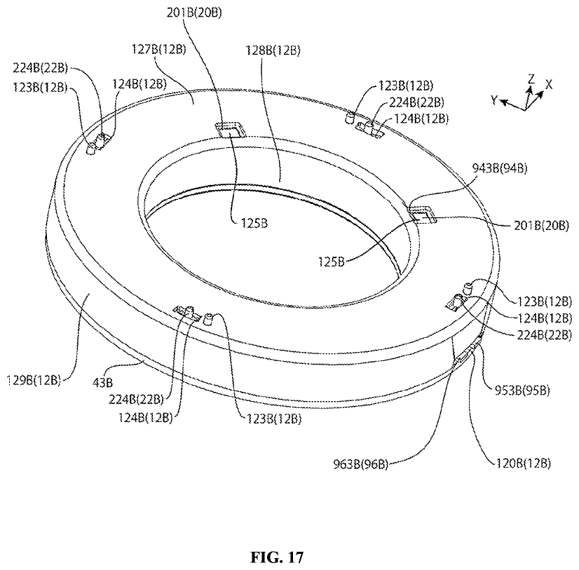

The front side coil substrate 20B is previously fixed to the rear surface of the disk portion 127B of the fixed plate 12B. And the lower edges of the inner peripheral wall portion 128B and the outer peripheral wall portion 129B of the fixed plate 12B are fixed to the inner peripheral edge and the outer peripheral edge of the base 43B. In the front side coil substrate 20B, the lands 201B are soldered and electrically connected to the front-end portions of the rising portions 943B of the first metal members 94B of the base 43B via the holes 125B. As shown in FIG. 17, the blade side receiving portions 953B and 963 of the base 43B are exposed to the outer periphery side via the notches 120B of the fixed plate B.

The front side coil substrate 20B, the movable ring 22B, the rear side coil substrate 40B, and the circuit board 41B are accommodated in an annular space formed between the inner peripheral wall portion 128B and the outer peripheral wall portion 129B of the fixed plate 12B. In this annular space, the coils 121B on the +X side, the −X side, the +Y side, and the −Y side of the front side coil substrate 20B and the rear side coil substrate 40B face each other with the magnets 21B on the X side, the −X side, the +Y side, and the −Y side sandwiched therebetween.

The Hall IC 42B is accommodated in the notch 401B on the −X+Y side of the rear side coil substrate 40B. The Hall IC 42B is located at a corner position between the group on the −X side and the group on the +Y side out of four groups composed of the magnets 21B and the coils 121B in the front and rear. The plate spring 30B on the −X+Y side is located on the front side of the Hall IC 42B. The six pads of the Hall IC 42B is electrically connected to the six lands on the front surface of the circuit board 41B.

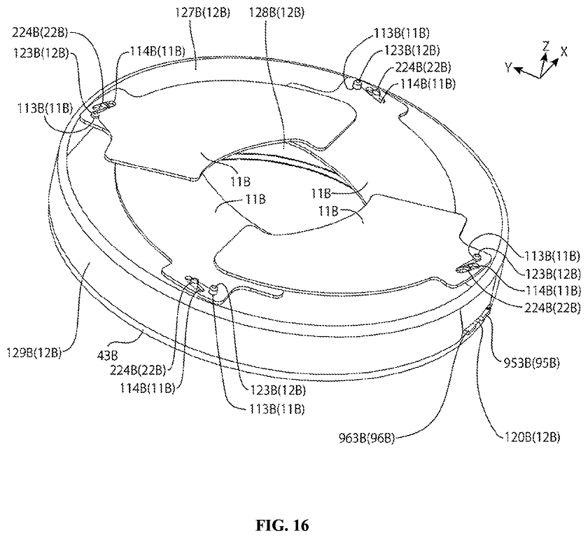

As shown in FIG. 17, the movable pins 224B of the movable ring 22B are passed through the long holes 124B of the fixed plate 12B and project forward. And then, as shown in FIG. 16, the fixing pins 123B of the fixed plate 12B are fitted into the fixing holes 113B of the blades 11B, and the movable pins 224B are fitted into the movable holes 114B of the blades 11B. The cover 10B is fixed to the outer peripheral edge of the disk portion 127B of the fixed plate 12B.

As shown in FIG. 13, the blade side receiving portions 953B and 963B protruding from the notches 120B on the +Y side and the −Y side of the blade driving device 1B are placed on the front-end portions of two carrier side receiving portions 701B on the +Y side and the −Y side of the lens carrier 70B, respectively. The carrier side receiving portions 701B and the blade side receiving portions 953B and 963B are fixed and electrically connected by welding or solder joining.

The Hall IC 42B connected to the carrier side receiving portion 701B detects the magnetic field of the magnet 21B to detect the position of the magnet 21B in the rotation direction with respect to the Hall IC 42B, and outputs electric current for supplying to the coil 121B based on the result. When an electric current is supplied to the coils 121B of the front side coil substrate 20B and the rear side coil substrate 40B of the blade driving device 1B, a thrust force in a direction around the optical axis is produced by the electromagnetic force generated by the coils 121B and the magnets 21B. The movable ring 22B rotates with respect to the fixed plate 12B by this thrust force. With this rotation, the movable pin 224B of the movable ring 22B moves in the movable hole 114B of the blade 11B, and the blade 11B rotates around the axis of the fixing pin 123B fitted in the fixing hole 113B.

The details of the present third embodiment are explained above. The blade driving device 1B according to the present third embodiment includes: blades 11B; four groups which respectively have a magnet 21B and at least one coil 121B facing the magnet 21B, and generate a thrust force for moving the blades 11B by an electromagnetic force between the magnet 21B and the coil 121B; and a Hall IC 42B which is a magnetic position sensor that detects the magnetic field of the magnet 21B to detect the position of the magnet 21B, wherein the Hall IC 42B is located at a position between two adjacent groups of the four groups. Accordingly, it is possible to provide a blade driving device 1B capable of arranging a magnetic position sensor even in a small space.

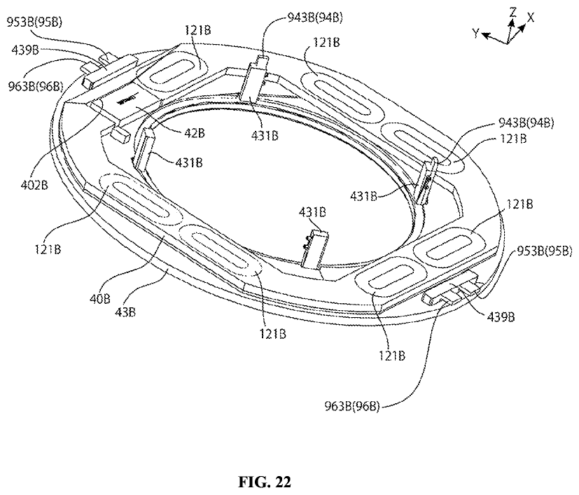

It is to be noted that in the third embodiment described above, the Hall IC 42B may be arranged at a position where predetermined one coil 121B among all the coils 121B should be located. For example, as shown in FIG. 22, the coil 121B may not be arranged at the position where the coil 121B on the −X side of the two coils 121B on the +Y side of the rear side coil substrate 40B should be located, but a notch 402B may be provided at this position, and the Hall IC 42B may be accommodated in this notch 402B. At this time, the Hall IC 42B faces the magnet 21B on the +Y side.

In addition, in the third embodiment described above, the coils may be fixed to the movable ring 22B, and the magnets may be fixed to the fixed portion. In addition, one magnet 21B may be provided for each coil 121B.

Further, in the third embodiment described above, the number of the groups of magnets 21B and coils 121B may be two groups, three groups or five groups or more.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A blade driving device in which a central axis is defined, comprising:
a plurality of blades arranged around the central axis; and
a plurality of groups each comprising a magnet and at least two coils, and arranged at intervals along a circumference of a circle centered on the central axis,
wherein a winding axis direction of the coil coincides with a normal direction of a facing surface of the magnet facing the coil, when viewed from the winding axis direction, magnetic poles formed on the facing surface are reversed at a position corresponding to a center of the coil, each of the groups generates an electromagnetic force along a circumference direction of the circle to drive the blades.

2. The blade driving device according to claim 1, wherein the winding axis direction of the coil and the normal direction of the facing surface of the magnet facing the coil face the central axis direction.

3. The blade driving device according to claim 1, wherein in each of the groups, the at least two coils provided on a front side of the central axis direction and the at least two coils provided on a rear side of the central axis direction sandwich the magnet.

4. The blade driving device according to claim 1, wherein when viewed from the central axis direction, the coils are connected and aligned along the circumference direction of the circle.

5. The blade driving device according to claim 1, wherein when viewed from the central axis direction, two or more coils are linearly connected and aligned.

6. The blade driving device according to claim 1, wherein in an alignment direction of the coils, areas of portions magnetized to one magnetic pole at both ends of the magnet are smaller than areas of other portions magnetized to one magnetic pole.

7. The blade driving device according to claim 1, wherein in an alignment direction of the coils, end portions of the magnet are located at positions corresponding to centers of the coils.

8. The blade driving device according to claim 1, further comprising:
a fixed portion; and
a movable ring which is supported so as to be rotatable about the central axis with respect to the fixed portion and drives the blades by rotation,
wherein one of the coils and the magnets are arranged at the fixed portion, and the other is arranged on the movable ring.

9. The blade driving device according to claim 1, wherein a winding axis direction of the coil and a normal direction of a facing surface of the magnet facing the coil face a radial direction centered on the central axis as a whole.

10. The blade driving device according to claim 9, wherein when viewed from the central axis direction, the at least two coils are linearly connected and aligned, and the magnetic poles are reversed at a position corresponding to a center of each coil.

11. The blade driving device according to claim 9, wherein when viewed from the central axis direction, the at least two coils are connected and aligned along the circumference direction of the circle, and the magnetic poles are reversed at a position corresponding to the center of each coil.

12. The blade driving device according to claim 10, wherein in an alignment direction of the coils, areas of portions magnetized to one magnetic pole at both ends of the magnet are smaller than areas of other portions magnetized to one magnetic pole.

13. The blade driving device according to claim 10, wherein in an alignment direction of the coils, end portions of the magnet are located at positions corresponding to centers of the coils at both ends.

14. The blade driving device according to claim 9, further comprising:
a fixed portion; and
a movable ring which is supported so as to be rotatable about the central axis with respect to the fixed portion and drives the blades by rotation, wherein one of the coils and the magnets are arranged at the fixed portion, and the other is arranged on the movable ring.

15. The blade driving device according to claim 1, further comprising a magnetic position sensor that detects a magnetic field of the magnet to detect a position of the magnet, wherein the magnetic position sensor is located at a position between two adjacent groups among the plurality of groups, or at a position where predetermined one coil among all the coils should be located.

16. The blade driving device according to claim 15, wherein the coils are arranged on a front side coil substrate on a front side of the magnet and a rear side coil substrate on a rear side of the magnet, and the magnetic position sensor is arranged in a notch provided in the rear side coil substrate.

17. The blade driving device according to claim 15, wherein the coils are arranged on a front side coil substrate on a front side of the magnet and a rear side coil substrate on a rear side of the magnet, and the magnetic position sensor is located at a position of the rear side coil substrate where the predetermined one coil should be located, and faces the magnet.

18. The blade driving device according to claim 15, further comprising:
a fixed portion; and
a movable ring that rotates with respect to the fixed portion and moves the blades by a thrust force for moving the blades; and
a plurality of plate springs supporting the movable ring,
wherein the magnetic position sensor is located at a position between the two adjacent groups, and one of the plurality of plate springs is located on the front side of the magnetic position sensor.

19. A camera device comprising the blade driving device according to claim 1.

20. An electronic apparatus comprising the camera device according to claim 19.
